(19) United States
(12) Patent Application Publication
(10) Pub. No.: US 2015/0208616 A1
(43) Pub. Date: Jul. 30, 2015

(54) ANIMAL LEASH APPARATUS

(71) Applicant: Lura B. Peck, Winter Park, FL (US)

(72) Inventor: Lura B. Peck, Winter Park, FL (US)

(21) Appl. No.: 14/594,679

(22) Filed: Jan. 12, 2015

Related U.S. Application Data
(60) Provisional application No. 61/965,269, filed on Jan. 27, 2014.

(51) Int. Cl. A01K 27/00; A45F 5/10

(52) U.S. Cl. CPC A01K 27/008; A01K 27/004; A45F 5/10

(57) ABSTRACT

The present invention is for an animal leash having a housing having a cell phone supporting attachment thereon for holding a cell phone. This allows the cell phone to be rapidly attached to the animal leash housing and to be quickly removed from the animal leash housing to thereby allow the user of the animal leash to use the cell phone hands free while walking their pet.

This application claims the benefit of U.S. Provisional Application No. 61/965,269, filed Jan. 27, 2014.

### FIELD OF THE INVENTION

This invention relates to an animal leash and especially to an animal leash having a support for a cell phone which allows a person to removably attach and use their cell phone while walking a pet.

### BACKGROUND OF THE INVENTION

Millions of individuals own dogs and other pets. Dog owners especially walk their dogs to exercise them in an overall health maintenance program. Many local ordinances require the use of a leash or tether when walking a dog in a public place. A typical animal leash may be an elongated flexible strap or cord or the like having a dog collar on one end and a leash holding member on the other end. However a common dog leash is held coiled in a retractable housing having a handle thereon and allows the pet owner to extend or retract the leash from the housing which may be done with one hand.

When walking their animal, many pet users often multitask, talking on their cell or smart telephones while strolling with their pet. Unfortunately, trying to control a spirited, leashed animal with one hand while using a cell phone can be difficult. This can result in the leash becoming tangled or in the user dropping the item they are holding or letting go of the leash.

A multifunctional pet leash storage device may be seen in U.S. Pat. No. 8,256,384 to Wheeler et al. which can store waste, sanitary bags and the like. A leash caddy system may be seen in U.S. Pat. No. 8,839,745 to Johnston which allows a retractable leash caddy system to be used in securing a retractable leash within a cover and to secure the leash to a person to afford hands free controlling of a pet. The Edwards et al. U.S. Pat. No. 6,240,881 is for a leash assembly having a pet refuse bag dispenser mechanism while U.S. Pat. No. 5,938,137 to Poulson is for a cellular phone leash. The Burkhardt U.S. Pat. No. 8,342,137 is for an animal leash which attaches to the waist of the user.

The present invention allows for the rapid attaching and removing of a cell phone or smart phone in a secure manner to a leash housing which allows the user to use the cell phone hands free while walking their pet.

### SUMMARY OF THE INVENTION

This invention relates to an animal leash having a cell phone attachment on the leash housing. The leash housing has a handle and a housing top portion. An elongated flexible leash is extendable from and retractable into the leash housing. A cell phone support supports a cell phone on the leash housing with the support fixedly attached to the top portion of the leash housing. The cell phone support has a cell phone supporting base having two end portions and an arcuate lip on one end portion thereof. An elongated flexible strap extends over the cell phone supporting base for strapping a cell phone to the cell phone supporting base. An angled cell phone positioning member is attached between the cell phone support and the animal leash housing for positioning a cell phone at an angle towards the user of the animal leash. One or more resilient pads, such as a polymer or elastomeric pad or a neoprene pad, are fixedly attached to the cell phone supporting base for holding a cell phone thereon. A cell phone may thus be removably attached to an animal leash housing for use when walking a pet.

### BRIEF DESCRIPTION OF THE DRAWINGS

The accompanying drawings, which are included to provide further understanding of the invention, are incorporated in and constitute a part of the specification and illustrate an embodiment of the invention and together with the description serve to explain the principles of the invention.

In the drawings:

FIG. 1 is a perspective view of an animal leash having a cell phone removably attached to the leash housing in accordance with the present invention; and

FIG. 2 is a perspective view of the animal leash of FIG. 1 without the cell phone attached.

### DETAILED DESCRIPTION OF AN EXEMPLARY EMBODIMENT

The present invention allows for the removably attaching of a cell phone to an animal leash housing to allow the use of the cell phone hands free while walking an animal.

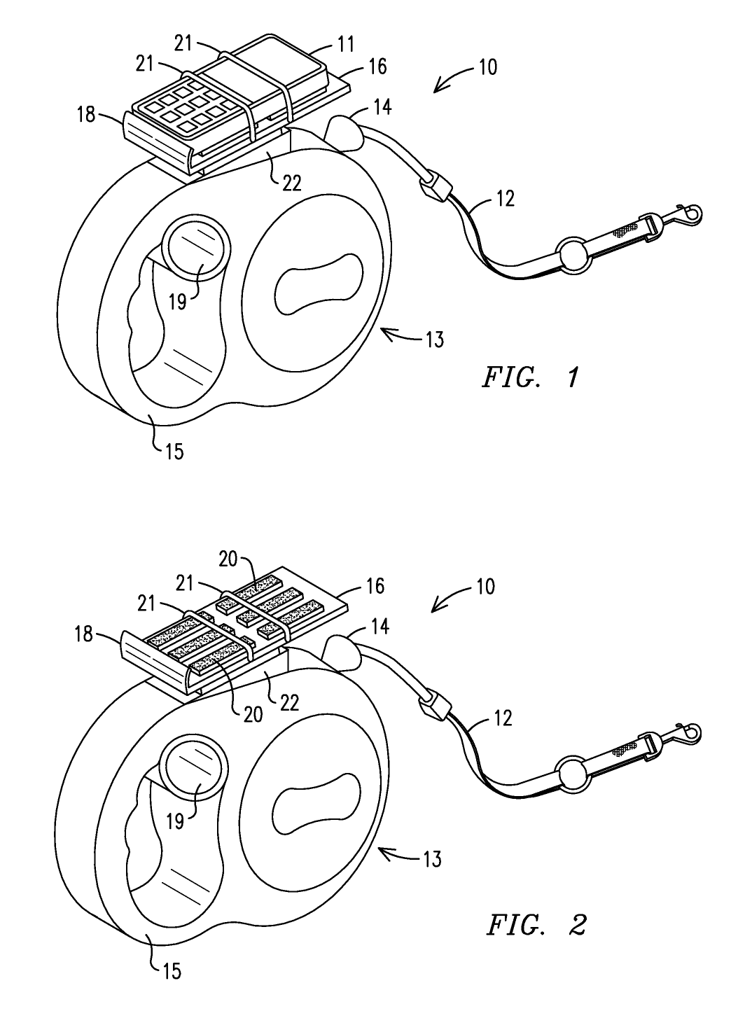

Referring to the drawings FIGS. 1 and 2, an animal leash 10 has a cell phone 11 attached thereto. The animal or dog leash 10 is shown having a leash 12 partially extending from a leash housing 13. The leash 12 is retractable into and extendable from the housing 13 and may be retracted until the stop 14 abuts the opening in the leash housing 13. The leash housing 13 has a handle 15 and may have a control finger ring 19 for controlling the extension of the leash 12.

As seen in the figures, the leash housing 13 has a cell phone support 16 attached thereto which support has a cell phone supporting base 17 having an arcuate lip on one end thereof. The cell phone supporting base 17 has a plurality of non-slip pads 20 thereon which may be polymer pads such as neoprene or any generally non-slip material. A plurality of pads 20 are illustrated in the drawings but it should be clear that one large pad or any number of pads may be used. A pair of elongated stretchable straps 21 extend over the cell phone supporting base 17 for holding a cell phone 11 thereto as seen in FIG. 1. The straps 21 may be rubber or elastomeric bands and one or any number of straps may be used as desired. A cell phone support positioning member or wedge 22 is positioned between the cell phone supporting base 17 and the leash housing 13 and has an angled surface supporting the cell phone supporting base 17 to position the cell phone 11 at an angle so that a person using the leash can better use the phone while walking a pet. The cell phone support positioning member 22 would typically be fixedly attached to the top of the cell phone leash housing 13 and to the bottom of the cell phone supporting base 17. However the cell phone supporting base 17 may be removable from the cell phone support positioning member 22 if desired.

It should be clear that the present animal leash cell phone attachment in accordance with the present invention allows for the attachment of all types and sizes of the cell phone, smart phones or the like. Cell phone as used in connection with the present application should be understood to mean any communication device such as a smart phone or the like.

In operation the cell phone 11 can be attached to the phone support 16 by expanding the elastic straps 21 and positioning the phone on the cell phone supporting base 17 and on the pads 20 with one end of the cell phone held in the curved lip 18 on the end of the cell phone supporting base 17. The straps 21 can then be released or tightened onto the cell phone 11. The phone 11 is then ready to use while walking a pet. The phone 11 is thus available for hands free operation with voice commands keeping a person ready to receive phone calls and for talking to other persons while walking the dog without the distraction of having to hold and operate the cell phone while walking the pet. After completing a pet's walk, the cell phone 11 is removed from the cell phone attachment 16.

It should be clear at this time that an animal leash with a cell phone attachment has been provided. However the present invention is not to be considered limited to the forms shown which are to be considered illustrative rather than restrictive.

I claim:

1. An animal leash with cell phone attachment comprising:
a leash housing having a handle and a top side;
an elongated flexible leash extendable from and retractable into said leash housing;
a cell phone support for supporting a cell phone thereto fixedly attached to the top portion of said leash housing, said cell phone support having a cell phone supporting base having two end portions and having a supporting lip on one end portion thereof;
an elongated flexible member attached to said cell phone supporting base and extendable over said cell phone supporting base for strapping a cell phone to said cell phone supporting base; and
a cell phone support positioning member attached between said cell phone support and said leash housing for positioning a cell phone at an angle facing a user of said animal leash;
whereby a cell phone may be removable attached to an animal leash housing for use when walking a pet.

2. The animal leash with cell phone attachment in accordance with claim 1 in which said cell phone supporting base elongated flexible member is a stretchable elastomer member for holding a cell phone to said cell phone supporting base.

3. The animal leash with cell phone attachment in accordance with claim 1 in which said cell phone supporting base has a pair of elongated flexible members for holding a cell phone to said cell phone supporting base.

4. The animal leash with cell phone attachment in accordance with claim 1 in which said cell phone supporting base supporting lip is an arcuate lip for holding one end of a cell phone therein.

5. The animal leash with cell phone attachment in accordance with claim 1 in which said cell phone supporting base has a polymer pad fixedly attached thereto for holding a cell phone thereon.

6. The animal leash with cell phone attachment in accordance with claim 1 in which said cell phone supporting base has a plurality of polymer pads fixedly attached thereto for holding a cell phone thereon.

7. The animal leash with cell phone attachment in accordance with claim 1 in which said cell phone supporting base has a neoprene pad fixedly attached thereto for holding a cell phone thereon.

8. The animal leash with cell phone attachment in accordance with claim 1 in which said cell phone supporting base elongated flexible member is a stretchable rubber strap.

9. The animal leash with cell phone attachment in accordance with claim 1 in which said cell phone supporting base elongated flexible member includes a plurality of stretchable rubber straps.

10. An animal leash with a cell phone attachment comprising:
a leash housing having a handle and having a top portion;
an elongated flexible leash extendable from and retractable into said leash housing;
a cell phone support for supporting a cell phone thereto fixedly attached to the top portion of said leash housing, said cell phone support having a cell phone supporting base having two end portions and having an arcuate supporting lip on one end portion thereof;
an elongated flexible strap extending over said cell phone supporting base for strapping a cell phone to said cell phone supporting base;
an angled cell phone positioning member attached between said cell phone support and said animal leash housing for positioning a cell phone at an angle facing a user of said animal leash; and
a resilient pad fixedly attached to said cell phone supporting base for holding a cell phone thereon;
whereby a cell phone may be removably attached to an animal leash housing for use when walking a pet.

11. The animal leash with cell phone attachment in accordance with claim 10 in which said cell phone supporting base resilient pad is a neoprene pad.

12. The animal leash with cell phone attachment in accordance with claim 10 in which said cell phone supporting base has a plurality of neoprene pads fixedly attached thereto for holding a cell phone thereon.

13. The animal leash with cell phone attachment in accordance with claim 11 in which said cell phone supporting base elongated flexible strap is an elongated stretchable flexible strap.

14. The animal leash with cell phone attachment in accordance with claim 11 in which said cell phone supporting base has a plurality of elongated flexible stretchable straps.
